(19) United States
(12) Patent Application Publication
(10) Pub. No.: US 2021/0282525 A1
(43) Pub. Date: Sep. 16, 2021

(54) WARM CREAM DISPENSER APPLICATOR DEVICE WITH WIRELESS HEATING

(71) Applicant: Youti Kuo, Penfield, NY (US)

(72) Inventor: Youti Kuo, Penfield, NY (US)

(21) Appl. No.: 17/194,258

(22) Filed: Mar. 6, 2021

(51) Int. Cl. A45D 27/22; A45D 27/04; A45D 40/00

(52) U.S. Cl. CPC A45D 27/22; A45D 27/04; A45D 2200/155; A45D 2200/056; A45D 40/0081

(57) ABSTRACT

A warm cream dispenser applicator device provided with a cream dispenser, a heating chamber and an applicator head for applying warm cream directly on skin without hand touching the cream. The applicator head consists of a flow channel shaft, a roller having two end wheels and a rubber sleeve having self-closing slits. Several heating means are described. The heating chamber containing a loop of flow channel is heated by a heating plate, a heat resistance wire or by an induction coil, in particular, by a combination receiver-induction coil, which is energized by a transmitter coil in an external power pad. Under a pumping pressure, a heated cream emerges from the slits to spread on the roller surface. A combination shaver including a shaving cream dispenser, a cream applicator and a razor unit is provided. Also provided is a warm cream dispenser having a cream applicator attached with a makeup brush. The applicator device with wireless heating is generally applicable to dispensing warm foam, gel, liquid, and specifically warm skin care creams.

### BACKGROUND

It is well known that having lukewarm water washing face is effective for softening facial hair and more comfortable for shaving. To have a prolonged effect of lukewarm skin, a shaving cream can be pre-warmed and applied directly on skin without being transferred from hand. In cosmetic skincare, lotions are preferably applied on warm skin for better penetration. The warmer temperature of the skin increases diffusion of the lotion and the permeability of the skin cell layers. Conventionally it requires a user to warn up the skin with warm towel. However, this step may be replaced by a warm cream applied directly on the skin if available.

On the other hand, skincare lotions such as face masks should not be applied by hand, as they can be mixed with bacteria on the hand and transferred to the face. For this reason, it is better to apply skin lotions with a brush having soft bristles so not to harm the skin. Furthermore, with limited-dexterity, an elderly man may need a caregiver to shave for him or an aged woman may feel difficult open cream container with two hands for makeup. Therefore, it is desirable to have a warm cream dispenser combined with a cream applicator that enables dispensing facial cream with one hand and applying the cream directly on skin without touching the cream.

### FIELD OF INVENTION

This invention relates to a cream dispenser applicator device with wireless heating for directly applying heated cream on skin.

### DESCRIPTION OF RELATED ART

In conventional wet shaving, two hands are required to apply shaving cream on skin. A user uses one hand holding a shaving cream dispenser to dispense the cream to the other hand, and subsequently uses this other hand to apply the cream on his or her skin for shaving. This two hand actions repeat a number of times until the targeted skin is wholly covered by the cream. In the process non-targeted areas are covered with the cream by swiping hand motion and extra cream is wasted due to uneven layer applied on the skin. It is also likely that the user would rinse the cream off from his or her hand before the actual shaving action. Therefore, it is desirable to have a shaving applicator device that integrates a shaving applicator head with a shaving cream dispenser for applying the cream directly on a user's skin with one hand operation. It is also desirable that the shaving applicator device delivers heated shaving cream for softening hair for removal.

PCT Patent Publication No. WO/2020/013906 by Kuo discloses a shaving applicator device having a roller applying shaving cream directly on skin without hand touching the cream. The applicator head consists of a flow channel shaft, a roller having two end wheels and a rubber sleeve having self-closing slits. Under a pumping pressure, the cream emerges from the slits to spread on the roller surface. Gliding the roller on skin surface can spread the cream on the skin evenly with predetermined thickness. A combination shaver including a shaving cream dispenser, an applicator head and a razor unit is provided. In the combination shaver the razor unit and the applicator head are positioned in parallel back to back with a clearance. However, the shaving cream exiting the applicator device is at room temperature, not heated for facilitating softening of hairs to be shaved.

U.S. Pat. No. 6,056,160 by Carlucci, et al. describes a heated foaming liquid dispensing apparatus. The foaming liquid, when initially heated in the dispenser's heat chamber may undesirably produce steam and or a runny liquid that would be dangerous to a user. The invention uses a trap placed near the outlet to capture the steam or runny liquid. Since the trap is not self-closing, therefore, a user still can get burn accidently by the heated foaming liquid.

U.S. Pat. No. 9,743,463 by Laghi, et al. deals with a shaving device using an induction heater for heating shaving or cosmetic products stored in a container which consists of an electrically conductive metallic target member having through-passages energized by the induction coil. The target member is floating in the product container. As the metallic target member is of a thin-layer screen-like plate configuration having short dwell time for the product to pass through, therefore, not effective for gaining sufficient heat to warm up the product.

U.S. Pat. No. 10,421,205 by Hodgson, et al. discloses heated shaving razors having a heated element. A heating element is mounted to the housing of a shaving razor cartridge for transferring heat during a shaving stroke. The heating is for warming up blades not as effective as warming shaving cream, which immerses hairs in warm moisture to soften hairs for shaving.

Therefore, it is desirable to have a handheld shaving applicator device that can dispense a heated shaving cream directly to skin for shaving. And it is desirable that the dispensing spout of the applicator device is self-closing for the safety of users not to get accidently burned by the heated shaving cream.

U.S. Pat. No. 10,420,175 by Saunamaki describes wireless warmers using wireless transmission coil, receiver coil, rectifier, control circuits and heating element for warming up articles such as boots and gloves. It uses wireless power transmitter coils to transmit electromagnetic energy to a heating element inside an article of clothing for heating. The wireless heating means employs a rectifier for converting AC current into DC for heating outdoor attires for hours of use. The use of rectifier is too complex for heating a shaving cream, which is only to be used for several minutes in daily routines.

It is therefore desirable to have a handheld shaving applicator device with wireless heating for generating warm shaving cream and for directly applying the shaving cream on skin for the comfort of shaving. It is further desirable that such a shaving applicator heating device does not have electrical contacts exposed on the external surface of the device for safety.

### SUMMARY

It is an object of the invention to provide a shaving applicator device having a cream dispenser and a heating chamber to deliver warm cream directly on skin without hand touching the cream. It is another object of the invention to provide an applicator device with wireless heating for easy handling without a power cord attached to the device. It is further object of the invention to provide an applicator device using a combination receiver-induction coil and a wireless transmitter power pad for wireless heating.

A shaving applicator device is provided with a shaving cream dispenser and an applicator head containing a flow channel shaft, a roller and a heating chamber. The roller has two end wheels and a rubber sleeve with self-closing slits. The roller is free to rotate on the flow channel shaft. The space between the flow channel shaft and the rubber sleeve forms a cavity for filling the cream that is pumped from the cream dispenser through the openings in the flow channel shaft. Under a pumping pressure, the cream exits from the slits of the rubber sleeve to spread on the roller surface.

The heating chamber includes a flow channel connecting to the nozzle of the dispenser and to the flow channel in the applicator neck. The flow channel has a winding loop pattern to provide long flow path to increase the dwell time of the shaving cream to pass through. The mass of the heating chamber is determined to achieve a level of heat capacity without additional heat input to heat up a desired quantity of the shaving cream exiting the heating chamber. A variety of heating means are described using electrical contacts on the external surface of the applicator device for inserting on the electrical contacts on a power station without using a power cord attached to the device. Such heating means include heating plate, insulated heat resistance wire and induction coil. Also described is the use of a receiver-induction combination coil for direct heating the heating chamber without using a DC rectifier. By using a transmitter power pad as a power source, the output AC current of the transmitter is transferred to the induction coil through the receiver coil directly, which concurrently generates magnetic flux that energizes the metallic core in the heating chamber encompassed by the induction coil.

Under a pumping pressure, a heated cream emerges from the slits to spread on the roller surface. Specifically, a combination shaver including a warm shaving cream dispenser, an applicator head and a razor unit is provided. Also provided is a warm cream dispenser attached with a cream applicator and a brush for makeup applications. The applicator device with wireless heating is generally applicable to dispensing warm foam, gel, liquid, and specifically warm skin care creams for deeper penetration into skin surface.

### BRIEF DESCRIPTION OF THE DRAWINGS

FIG. 1a is a cream dispenser applicator device with wireless heating having a cream dispenser and an applicator head.

FIG. 1b is a side view of the cream dispenser applicator device shown in FIG. 1a.

FIG. 1c shows the detachment of the cream cartridge from the applicator head.

FIG. 1d-1 illustrates a cream inside the roller of the cream dispenser applicator device shown in FIG. 1a.

FIG. 1d-2 illustrates the cream exiting in radial direction from the roller.

FIG. 1d-3 illustrates the cream spreading on the roller surface.

FIG. 1e shows a gap between the roller sleeve and two wheels in contact with skin.

FIG. 2a is an enlarged view of heating chamber having a looped flow channel.

FIG. 2b is an enlarged view of heating chamber having a reservoir.

FIG. 2c is a heating chamber with a heating wire.

FIG. 2d is an enlarged view of the heating chamber.

FIG. 3a shows an operating station of the wireless heating for a cream dispenser applicator device.

FIG. 3b shows the electrical contacts of the applicator device in contact with the electrical contacts of the operation station.

FIG. 4 illustrates a heating chamber with an induction coil.

FIG. 5a illustrates a combination receiver-induction coil.

FIG. 5b shows a combination receiver-induction coil in a cream dispenser applicator device.

FIG. 5c shows an operating station of the cream dispenser applicator device using a combination receiver-induction coil.

FIG. 5d shows a dispenser applicator device with receiver coil situated inside coil compartment at the bottom end of the device.

FIG. 5e shows a wireless transmitter pad used for the cream dispenser applicator device using a combination receiver-induction coil.

FIG. 6 shows a cream dispenser applicator device using a battery as the power source.

FIG. 7 is a cream dispenser applicator device using a gel pump cartridge.

FIG. 8a is a combination shaver device having a heated dispenser, an applicator head, and a razor blade unit.

FIG. 8b is a side view of the combination shaver device shown in FIG. 8a.

FIG. 8c shows the razor blade unit of the combination shaver device shown in FIG. 8a.

FIG. 9a is a combination brush device having a heated dispenser, an applicator head, and a brush unit.

FIG. 9b is a side view of the combination brush device shown in FIG. 9a.

FIG. 9c shows the brush unit of the combination brush device shown in FIG. 9a.

### DETAILED DESCRIPTION

Throughout the following detailed descriptions, same reference numerals refer to the same elements in all figures. Here the term “wireless heating” generally refers to heating a targeted content of a handheld device without having a power cord attached to the handheld device. The term “cream” generally refers to fluid, gel, lotion, paste, and specifically facial cream and shaving foam.

Main Structures

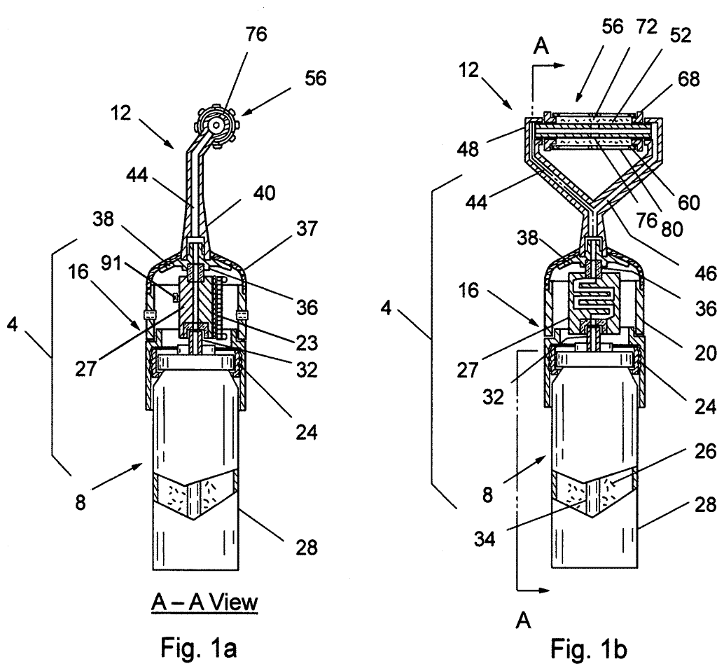

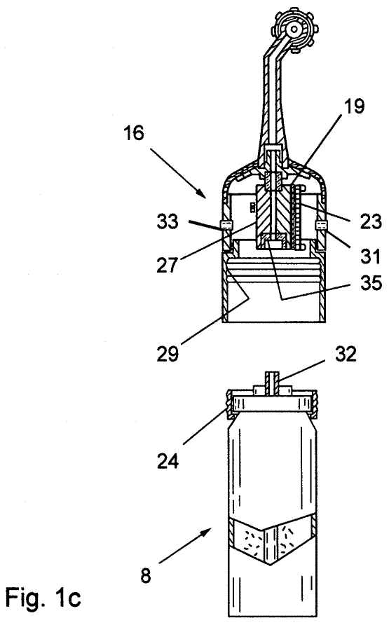

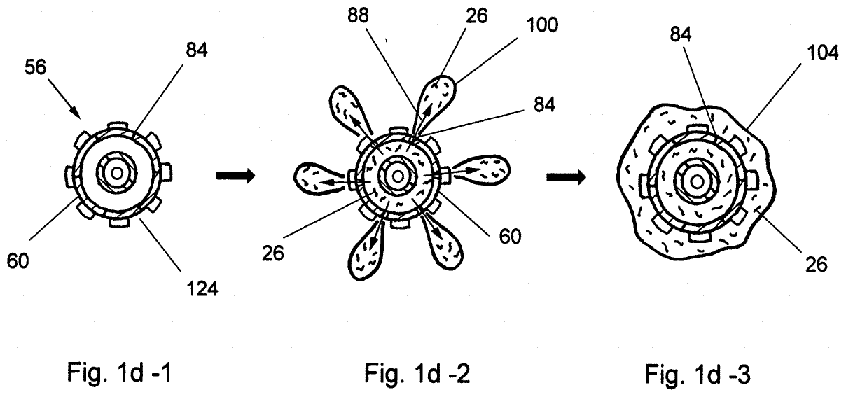

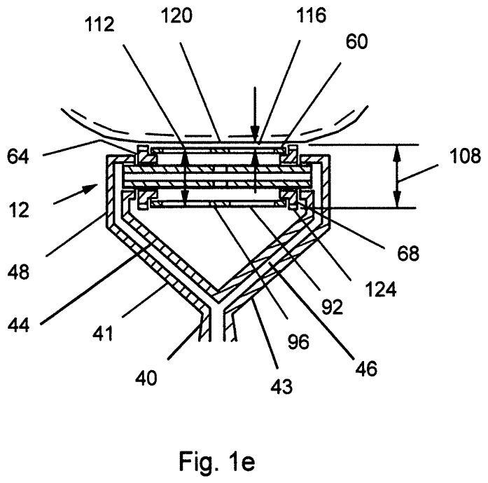

The structure and the function of a cream dispenser applicator device of the present invention are described below, as an example, in a shaving cream application for shaving. It is noted here that the structure and the function as described are also applicable for facial cream applications and others dispensing heated creams. As shown in FIGS. 1a, 1b, a shaving applicator device 4 of the present invention includes shaving cream dispenser 8, shaving applicator 12, heating chamber 27, heating element 23 and housing 16. Housing 16 has upper frame 20 and lower frame 24 (shown in FIG. 1b) supporting dispenser 8 and applicator 12 respectively.

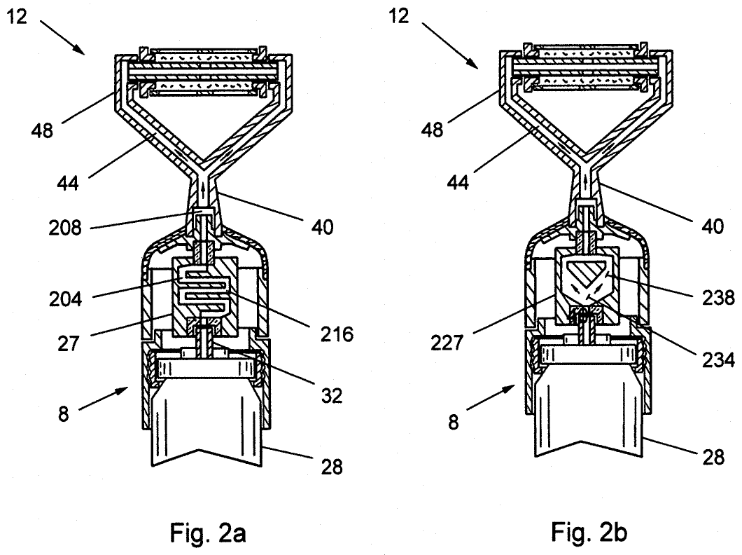

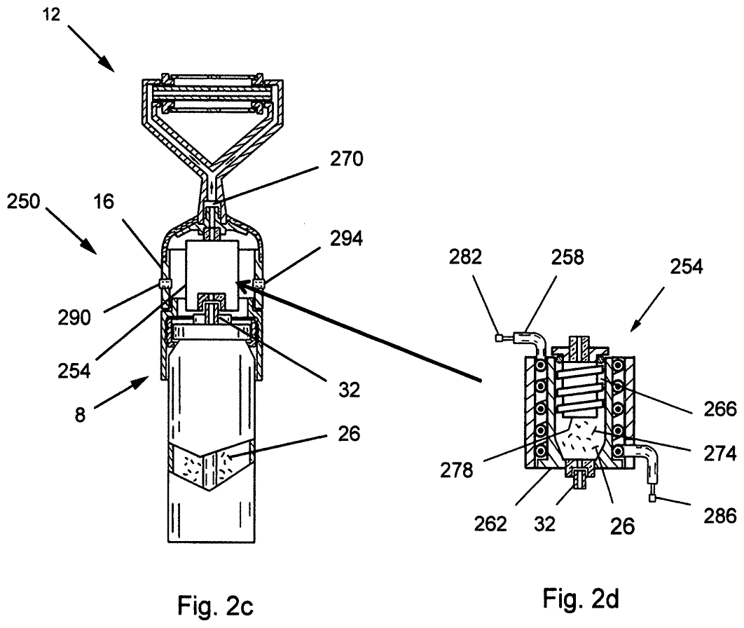

Dispenser 8 includes cartridge 28 containing shaving cream 26, nozzle 32, dip tube 34, and actuator 36 with lever 38. Applicator 12 has neck 40 with extended two arms including flow channels 44, 46 extending from nozzle 32 to applicator head 48. Applicator head 48 includes flow channel shaft 52 receiving cream 26 from dispenser 8 and roller 56 for exiting the cream through openings on its surface. Roller 56 has annular wall 60 mounted between first end-cap wheel 64 and second end-cap wheel 68 that together forms cavity 72 encompassing flow channel shaft 52. End wheels 64, 68 are mounted on flow channel shaft 52 with sealing-fit and free to rotate. Flow channel shaft 52 is in flow communication with flow channels 44, 46 in neck 40 and has outlet openings 76 to fill cavity 72 with cream 26 pumped from dispenser 8. And annular wall 60 has an array of openings 80 through the thickness of the wall, which are spaced apart to distribute the cream evenly on the outer surface. In a preferred embodiment annual wall 60 is a resilient rubber sleeve with openings formed by slit cuts 84 as shown in FIG. 1d-1, which shows roller 56 in FIG. 1b. The slits are forced to open, as shown in FIG. 1d-2, to exit the cream under a pumping pressure, represented by arrows 88, created by pressing on actuator 36 of the dispenser to force the flow of cream 26 from cartridge 28 to flow channel shaft 52 to cavity 72. FIG. 1d-2 also shows jetting 100 of the cream at the slit openings under a pumping pressure. Slits 84 can close by themselves due to the resiliency of the rubber material when the pumping pressure is reduced or removed upon the release of actuator 36 from a depressed position. In a preferred embodiment, as shown in FIG. 1d-2, slits 84 can be cut at 60° apart along the circumference of rubber sleeve, i.e. annular wall 60. In a preferred embodiment as shown in FIG. 1e, rubber sleeve 60 has two slit segments 92, which are spaced along the axial direction, and un-cut segment 96 in between to maintain the rigidity and strength of the rubber material for self-closing and returning to the original un-deformed state of the rubber sleeve. At the end of pump action the jetting becomes spreading 104 on the rubber sleeve surface due to fluidity, surface tension and gravity of the cream. The objective of using the self-closing slits is preventing drying in case of using shaving gel and preventing oozing in using shaving foam. For shaving foam, the foam may slowly oozing out of openings on the roller surface if the openings are not closed due to remaining foam pressure inside the cavity when the actuator is released or the pumping action is stopped. The self-closing of the slit openings due to the elastic force of the rubber sleeve keeps the shaving foam inside the cavity and preventing any contaminants from entering the cavity.

Dome-Shaped Resilient Rubber Cap

Further embodiment of the present invention is a pumping means of using a dome-shaped resilient rubber cap 37 (Shown in FIG. 1a) as part of actuator 38 for pumping to avoid any rinsing water into the pumping mechanism of the shaving applicator device. FIG. 1a shows that dome-shaped rubber cap 37 is attached to the base of neck 40 to cover upper frame 20 of the housing from water penetration so that rubber cap 37, neck 40 and actuator 38 moves together. The underside of rubber cap 37 is bonded to rigid actuator 38 for depressing the neck to pump shaving cream inside dispenser 8. The resilient and elastic nature of the rubber cap can cause the neck to spring back to its original shape when the dome-shape cap and actuator is released from a depressed position. The smooth surface of the rubber cap is easy for cleaning after using the shaver device.

Threaded Sleeve

The dispensing actuation of the shaving applicator device depends on the displacement of the cartridge nozzle against the cartridge housing, specifically against the rim shoulder of the housing. To control the displacement of the nozzle, as illustrated in FIG. 1c, cartridge 8 of the present invention has rim shoulder 24 which has external threads 24. External threads 24 engage with internal threads 29 on the base of applicator device 16. For setup, with the threads engagement, fine turning cartridge 8 can precisely advance nozzle 32 against inlet wall 35 of heat chamber 27 for flush contact or barely contacting without forcing the shaving cream out of nozzle 32 before use.

End Wheels

Referring to applicator 12 as shown in FIG. 1e, first end-wheel 64 and second end-wheels 68 are supported by two arms 41, 43, which include flow channels 44, 46 extending from nozzle 32. In a further embodiment of the present invention, outside diameter 108 of first end-wheel 64 and second end-wheels 68 is larger than outside diameter 112 of rubber sleeve 60 for forming gap 116 between the two wheels and the rubber sleeve when the two wheels are in contact with a flat surface or an user's skin 120. Each wheel has grooves 124, as shown in FIG. 1d-1 and FIG. 1e, for the ease of rotating roller 56. In application, after pumping the cream is forced out to spread on the surface of the rubber sleeve. When the roller is glided or driven on a user's skin, the cream fills up the gap to form a cream layer left on the skin. This swath of cream layer is nearly uniform. Repeated pumping can provide additional cream needed to cover the entire target area of the skin to be shaved. After shaving, rinsing of the roller can easily remove residual cream from the roller surface and keep the roller surface clean.

Heating Chamber

Heating chamber 27 is heated by a heating means. As shown in FIG. 2a, which is an enlarged view of heating chamber 27 in FIG. 1a, the heating chamber includes flow channel 204, which has inlet port 208 receiving the shaving cream from nozzle 32 of dispenser 8, to deliver the shaving cream to flow channel 44 in applicator neck 40. Flow channel 204 has winding loop pattern 216 to provide long flow path to increase the dwell time or residence time for any element of the shaving cream to pass through. In another embodiment of a heating chamber of the present invention is a heating chamber having a reservoir. As shown in FIG. 2b, heat chamber 227 has reservoir 234 situated at the entrance of flow channel 238 for storing a volume of the cream for heating during the ramp up time of heating chamber 227 prior to dispensing the cream to applicator head 12. Furthermore, the mass of the heating chamber is predetermined to achieve a level of heat capacity without additional heat input, i.e. after turning off the heat source, to heat up a desired quantity of the shaving cream with a minimum required temperature exiting the heating chamber. This mass requirement is necessary as the handheld applicator device is to be used for shaving without a power cord attached. A handheld shaving applicator device using an external or an internal power source will be described in later sections.

Heating Plate

A heating means for providing heat to the foaming liquid includes heating plate 23 as shown in FIG. 1a, which is attached to a sidewall of heating chamber 27 for heat conduction from the heating plate to the heating chamber. The heating plate is made of high resistive material such as nichrome (NiCr) resistance heating alloy. It is attached to the heating chamber with a thermally-conductive electrical-insulative layer 19, such as an aluminum nitride substrate, as an interface spacer. Aluminum nitride has high thermal conductivity and high volume resistivity to prevent electrical current through the heating element to the heating chamber. Alternatively, the heating plate is in a form of thick film heater, commonly aluminum 6061-T6, which is a type of resistive heater that can be printed on a thin metal substrate using metal/alloy-loaded thick film pastes. Thick film elements are advantageous in fast thermal response due to high watt density and wide range of voltage compatibility. Another alternative is the use of a polymer PTC (positive temperature coefficient) heating element, which is made of conductive rubber. A PTC heating element's resistivity increases exponentially with increasing temperature. Such a heater will produce high power when it is cold, and rapidly heat up itself to a constant temperature, beyond which the heating element becomes self-limiting. The self-limiting feature enables the operation of the heating plate without the need for overheat protection.

In another embodiment heating plate 23 is electrically connected (not shown) to electrical contacts 31, 33 situated on the outer surface of housing 16 for electrical communication with an external power source. With the heating chamber connected between the dispenser nozzle and the applicator neck entrance, the depression of applicator neck 40 forces the shaving cream to flow from dispenser 8 and get heated by heating chamber 27 to exit slits 84 of roller 56. The roller captures a quantity of the shaving cream around its surface before the user applies the heated shaving cream to his or her skin for shaving.

Temperature Switch

The heating chamber can be prevented from overheating by using a temperature switch. In one embodiment a bimetallic temperature switch is used in electrical connection between a heating element, either a heating plate or an induction coil, and a power source. In implementation, the temperature sensing surface of sensor switch 91, as shown in FIG. 1a is attached to the external surface of heating chamber 27. The bimetallic switch is selected to be normally closed for electrical input to the heating element up to a predetermined temperature limit. Beyond the preset temperature limit, the bimetallic switch is open that results in terminating the power input to the heating element so as to prevent overheating of the heating chamber. When the temperature of the heating chamber drops below the temperature limit, the switch closes again to resume power input to the heating chamber.

Heating Wire

The heating chamber can also be heated by a heat resistance wire. FIG. 2c shows shaving applicator device 250 having heating chamber 254 attached with heat resistance wire 258 for heat transfer. FIG. 2d shows an enlarged view of heating chamber 254. Heating chamber 254 is wound around by an insulated heat resistance wire 258, which is typically made of a Nichrome element having high resistivity. The heat resistance wire is electrically insulative but thermally conductive. Heat chamber housing 262 is of a cylindrical sleeve encompassing a spiral flow channel 266 connecting to inlet 270 of applicator head 12 and to chamber reservoir 274, which receives the cream 26 from outlet nozzle 32 of dispenser 8. Specifically, spiral flow channel 266 is a threads-like groove formed on the outer surface of cylindrical core 278, which is snug-fitted inside chamber housing 262. Reservoir 274 is for storing cream 26 for preheating during the warm-up period of the heating chamber to shorten the heating time for the cream exiting the applicator head. Additionally, the insulated heating wire is protected by a shield, which provides heat insulation. The two electrical contacts 282, 286 of heating wire 258 are connected to external electrical contacts 290, 294 situated on the outer surface of housing 16 for electrical communication with an external power source.

Operating Station

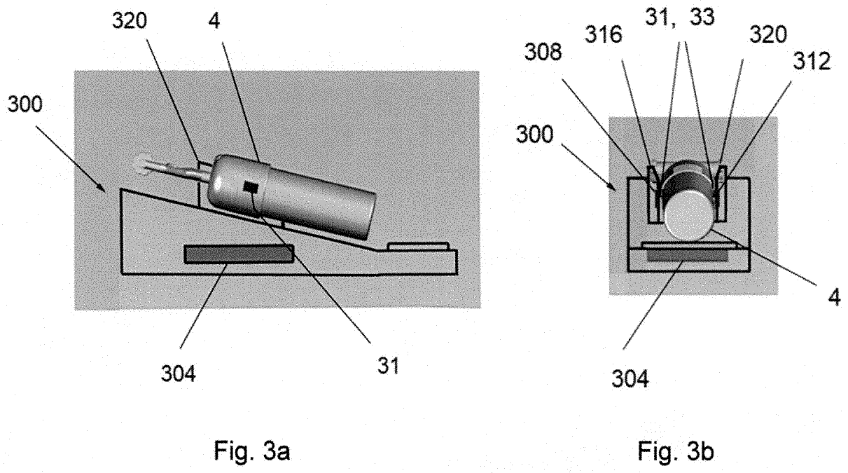

The power source and the operating system of a handheld shaving applicator device with a heating system can be either outside or inside the device. FIG. 3a shows operation station 300 of shaving applicator device 4 of the present invention using a heating element as described in FIG. 1a. The operating station includes a control system 304 comprising a AC-DC converter, a timer, a switch, a control circuit, indicator lights, electrical contacts, and a power cord attached to a power source. As shown in FIG. 3b, electrical terminals 308, 312 are in a form of two-prong socket, which consists of two springy contact levers 316, 320 spaced apart for inserting two electrical contacts 31, 33 on the outer surface of the shaving applicator device 4. FIG. 3b shows the insertion of device 4 on operation station 300 with electrical contacts 308, 312 engaged with socket levers 316, 320 for electrical communication for power input. The timer controls the heating time, i.e. the duration of current input to the heating chamber. The heating time can be in three levels, low, medium and high, indicated by three buttons with different light colors to meet a user's need for his or her temperature level of the exiting shaving cream.

Induction Coil

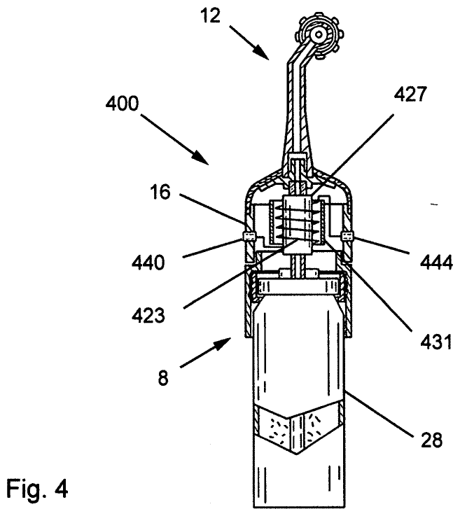

Another heating means for providing heat to the heating chamber is induction coil. The use of induction coils for heating is known in the art. FIG. 4 shows cream dispenser applicator device 400 of the present invention having heating chamber 427 encompassed by induction coil 423. The heating chamber has similar flow channel configuration like heating chamber 27 described in FIG. 2a or heating chamber 230 described in FIG. 2b. Induction coil 423 is of helical configuration situated inside coil support shield 431 for protection to prevent the coil from contacting the heating chamber to avoid short-circuiting. When the coil is energized by electrical AC current, an electromagnetic field is created that passes electromagnetic energy into the conductive heating chamber. By this process, only the metallic heating chamber 427 is heated by the electromagnetic energy, which is then transferred to the shaving cream (not shown) inside its flow channel, which is similar to flow channel 204 (shown in FIG. 2a) or flow channel 238 (shown in FIG. 2b). Similarly, induction coil 423 is electrically connected to electrical contacts 440, 444 on the outer surface of the housing 416 for electrical communication with an external power source, or to a rechargeable battery situated at the bottom of the handheld applicator device.

Combination Receiver-Induction Coil

An additional heating means is wireless induction heating using transmitter and receiver coils to energize an induction coil directly for heating without converting AC to DC by a rectifier. In the above-described heating means by heating plate and induction coil, electrical contacts are attached to and exposed on the external surfaces of the handheld applicator device. In the wireless induction heating means to be described below, electrical contacts are not attached to and exposed on the external surfaces.

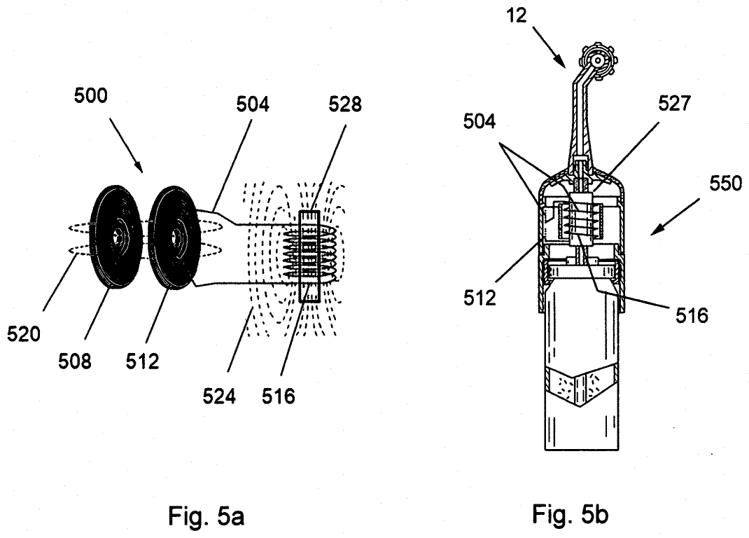

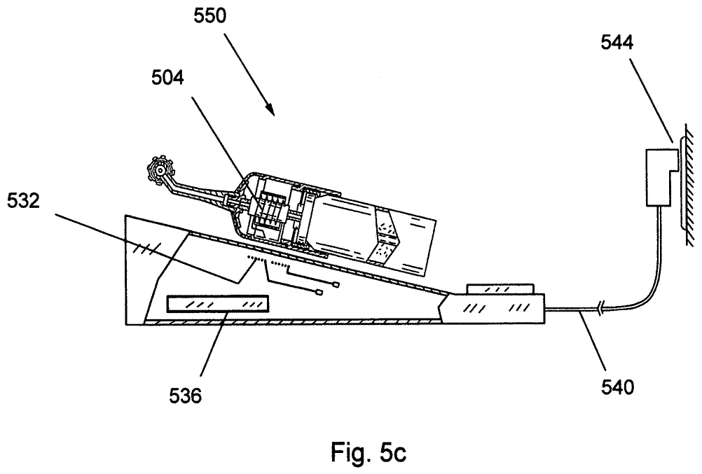

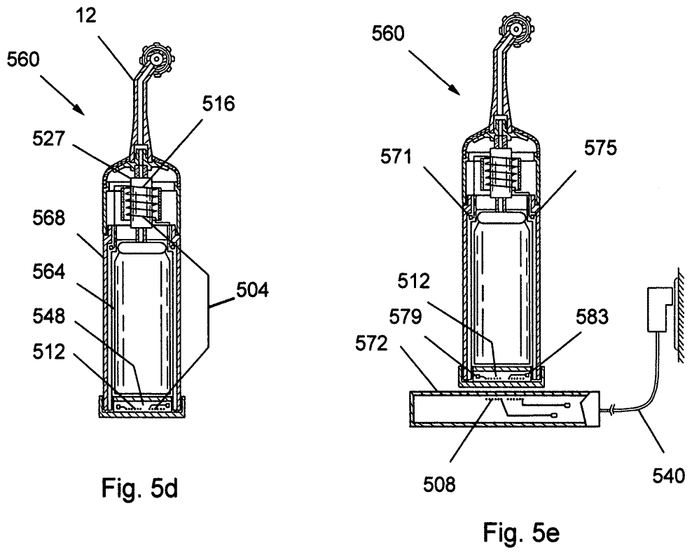

FIG. 5a shows system configuration 500 of the wireless induction heating of the present invention using combination receiver-induction coils 504. Transmitter coil 508 is to be situated in an operating station which is connected to a power source. Combination receiver-induction coils 504 consists of planar receiver portion 512 and induction coil portion 516. Separated by a device wall (not shown), receiver coil portion 512 is energized by transmitter coil 508 when magnetic flux 520 is generated by the power source. In the conventional function of a receiver coil, the output current is rectified to DC and stored in a battery or transferred to a load. But in receiver-induction coils 504, the output AC current of receiver coil 512 is transferred to induction coil 516, which concurrently generates magnetic flux 524 that energizes metallic core 528, which is encompassed by induction coil 516. In implementation on a shaving applicator device of the present invention, FIG. 5b shows the structure configuration of dispenser applicator device 550 having receiver-induction coils 504 situated with respect to heating chamber 527. Note that no external electrical contacts are used. When receiver coil 512 (shown in cross-section view) is energized by transmitter coil 508 of the power source, induction coil 516 creates a magnetic flux that heats up the heating chamber 527, which is similar to heating chamber 427 in configuration and function as described previously in FIG. 4.

The operating station, as shown in FIG. 5c, includes transmitter coil 532, and control system 536, which includes a timer, a switch, a control circuit, indicator lights, and a power cord 540 attached to power source 544. The timer controls the heating time, i.e. the duration of current input to the heating chamber. The heating time can be in three levels, low, medium and high, indicated by three buttons with different light colors to suit a user's need for his or her temperature level of the exiting shaving cream.

A further embodiment of the present invention is a dispenser applicator device having a receiver coil positioned at the bottom end of the device. FIG. 5d shows dispenser applicator device 560 with receiver coil 512 situated inside coil compartment 548 at the bottom end of the device. Device 560 has cream cartridge 564 inserted into handle wall 568. The handle wall is in a form of cylindrical sleeve imbedded with electrical lead wires (not shown), whose top ends 571, 575 (shown in FIG. 5e) connecting to induction coil 516 around heating chamber 527 and lower ends 579, 583 (shown in FIG. 5e) connecting to receiver coil 512 at the bottom end of the handle forming a complete receiver-induction coils 504 as described in FIG. 5a. FIG. 5e shows wireless transmitter pad 572 used for cream dispenser applicator device 560 using combination receiver-induction coils 504. Transmitter pad 572, which is connected to an AC power source, contains transmitter coil 508 for electrical coupling with receiver coil 512 of the dispenser applicator device 560.

Heating by Battery

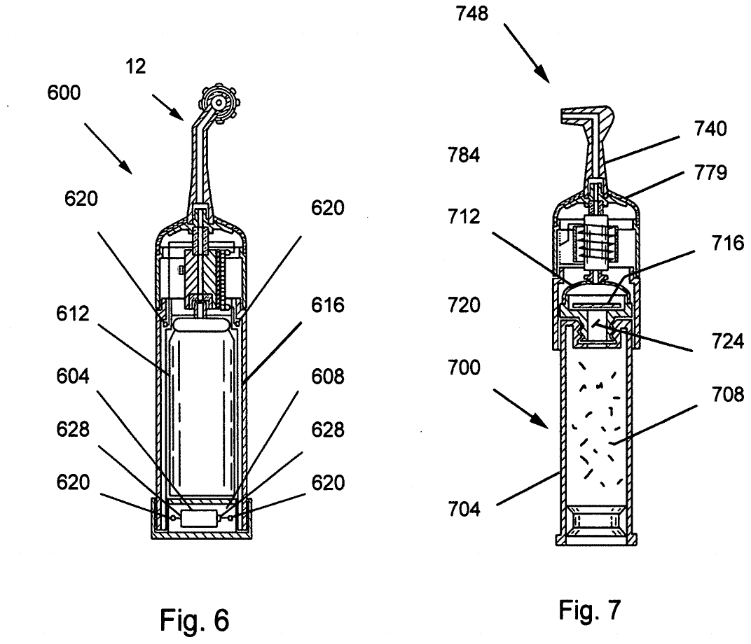

In the above heating means by heating plate or heat resistance wire, the applicator device uses external power source. The same heating means by DC current can be powered by a battery placed at the bottom of the device. FIG. 6 shows applicator device 600 of the present invention having battery 604 placed inside the compartment 608 below cream cartridge 612. The compartment is a part of the handle encompassing the cartridge and handle wall 616 contains electrical contact leads 620. The contact leads 620 are in electrical communication with electrical contacts 624 of the heating element and terminals 628 of the battery.

Piston Pump Cartridge

The configuration of applicator head of the shaving applicator device as described above is applicable to a dispenser that contains shaving foam or shaving gel. Specifically, the dispenser illustrated in FIGS. 1a, 1b is applicable for a shaving foam dispenser using a replaceable pressurized cartridge or an aerosol cartridge. The structure and function of a pressurized or aerosol dispenser is well known in the art. For using a shaving gel dispenser, FIG. 7 illustrates gel dispenser 700 using applicator head 784, replaceable cartridge 704 containing shaving gel 708. The gel dispenser employs rubber button 712 with one-way valve 716 for pumping shaving gel 708. Cartridge 704 may be a rigid-tube type with a movable disc (piston) to compact the gel cream during pumping action. When resilient dome-shaped cap 779 (similar to the resilient cap 37 as described in FIG. 1a) is depressed, rubber button 712 is pushed down to cause one-way valve 716 close on outlet 724 of cartridge 704 and force the gel inside pumping chamber 720 to exit from outlet 784 of applicator head 748. When the resilient dome-shaped cap 779 is released from the depressed position, rubber button 712 bounces back and creates a vacuum force causing valve 716 open to allow the gel flow into the pumping chamber 720 from cartridge 704. Outlet 784 may be a conventional nozzle or a wide opening for applying a swath of cream on the skin.

Combination Shaver

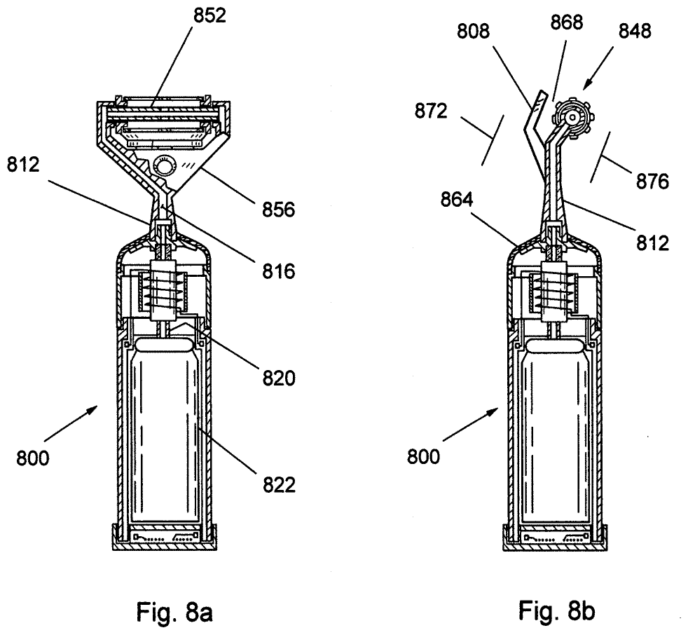

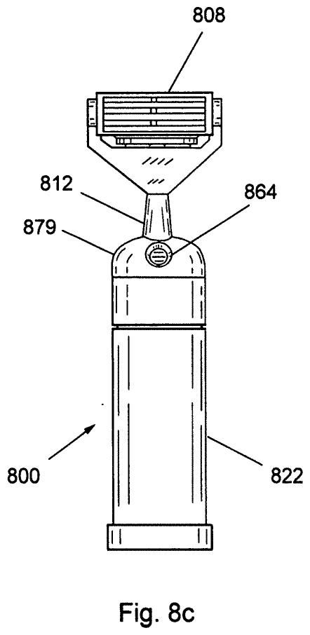

Another embodiment of the present invention is a combination shaver that combines a razor unit, a heated shaving cream dispenser, and a cream applicator in one device. As shown in FIGS. 8a, 8b and 8c combination shaver 800 of the present invention is a heated shaving applicator device attached with replaceable razor unit 808 on unitary neck 812. One function of unitary neck 812 is providing a common support structure that contains flow channel 816, which connects outlet nozzle 820 of dispenser 822 with flow channel shaft 852. Neck 812 also includes detachable mounting mechanism 856 for supporting replaceable razor blade unit 808. Neck 812 moves with actuator 864, which is integrated with dome-shaped resilient rubber cap 879, for pumping the shaving cream inside the dispenser. Razor blade unit 808 is positioned in parallel with cream applicator head 848 with clearance 868 between them such that the shaving side 872 of blade unit 808 is opposite to cream spreading side 876 of applicator head 848. In practice, after pumping and using the cream applicator to spread the shaving cream on the skin, the user can just flip the device to shave with continuous one hand motion without interruption.

Warm Cream Pump with Brush

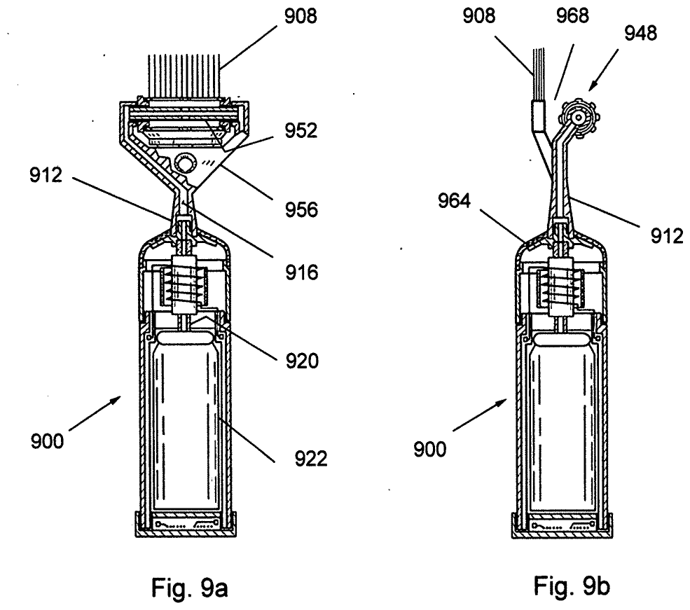

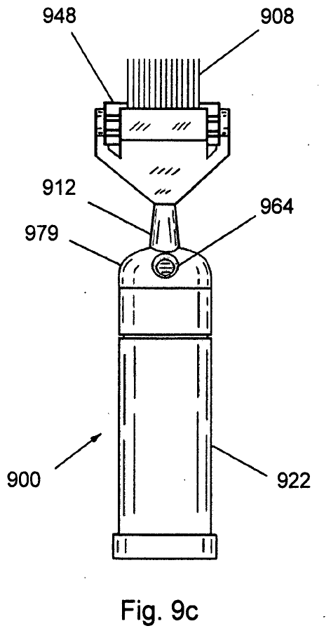

Another embodiment of the present invention is a warm-cream pump brush device that combines a brush unit, a warm cream dispenser, and a cream applicator in one device. As shown in FIGS. 9a, 9b and 9c warm-cream pump brush device 900 of the present invention is a warm cream dispenser having a cream applicator attached with replaceable brush unit 908 on unitary neck 912. One function of unitary neck 912 is providing a common support structure that contains flow channel 916, which connects outlet nozzle 920 of warm cream dispenser 922 with flow channel shaft 952. Neck 912 also includes detachable mounting mechanism 956 for supporting replaceable brush unit 908. Neck 912 moves with actuator 964, which is integrated with dome-shaped resilient rubber cap 979, for pumping the cream inside the dispenser. Brush unit 908 is positioned in parallel with cream applicator head 948 with clearance 968 between them such that they do not interfere with each other. In practice, after pumping and using the cream applicator to spread the cream on skin on some spots, the user can flip the device to use the brush to smoothen the cream on the skin with continuous one hand motion without interruption.

It is within the scope of this invention that the concept and mechanisms of wireless heating is applicable to fluid dispensers used in handheld cosmetics and medical devices. For example, an applicator device can dispense warm skin care cream for cold weather protection and for facial massaging with deep penetration into skin surface. In medical applications, a fluid dispenser with wireless heating can be used in a handheld PCR (polymerase chain reaction) device for dispensing primers for disease detections.

### REFERENCES

| | | | | Relevant |
|---|---|---|---|---|
| | | | | passages |
| Cite | Publication | Publication | Name of | (pages, |
| No. | Number | Date | Applicant | lines) |
| 1 | PCT/US2019/030167 | Jan. 16, 2020 | Y. Kuo | Page1, |
| | WO 2020/013906 | | | Abstract |
| 2 | U.S. Pat. No. | Apr. 10, 2007 | Carlucci, | Page1, |
| | 6,056,160 | | et al. | Abstract |
| 3 | U.S. Pat. No. | Aug. 22, 2017 | Laghi, et al. | Page1, |
| | 9,743,463 | | | Abstract |
| 4 | U.S. Pat. No. | Sept. 24, 2019 | Hodgson, | Page1, |
| | 10,421,205 | | et al. | Abstract |
| 5 | U.S. Pat. No. | Sep. 17, 2019 | E. Saunamaki | Page1, |
| | 10,420,175 | | | Abstract |

I claim:

1. A cream dispenser applicator device with wireless heating comprising:
i. a housing having a lower frame and an upper frame,
ii. a cream dispenser attached to the lower frame of said housing, said dispenser having a cartridge with an output nozzle containing a cream, a pumping means with an actuator for dispensing said cream,
iii. a heating chamber heated by a heating means having electrical contacts attached to the upper frame of said housing, said heating chamber having an flow channel with an output port and an input port receiving said cream from said cartridge, and
iv. an applicator head attached to the upper frame of said housing being in communication with said heating chamber, said applicator head comprising a flow channel shaft receiving said cream from said output port of said heating chamber, said flow channel shaft having a perforated annular wall for exiting said cream when said actuator of said cream dispenser is depressed to apply a pumping pressure.

2. The cream dispenser applicator device with wireless heating of claim 1, wherein said flow channel shaft is mounted with a roller having an annular wall situated between a first end-cap and a second end-cap forming a cavity encompassing said flow channel shaft for receiving said cream from said flow channel shaft, said annular wall having an array of openings spaced apart for exiting said cream.

3. The cream dispenser applicator device with wireless heating of claim 1, wherein said heating chamber is made of metallic material for conducting heat energy to said flow channel containing said cream.

4. The cream dispenser applicator device with wireless heating of claim 1, wherein said heating means comprises a heating plate with said electrical contacts on the outer surface of said housing for engaging with a power source.

5. The cream dispenser applicator device with wireless heating of claim 1, wherein said heating means comprises a heat resistance wire with said electrical contacts on the outer surface of said housing for engaging with a power source.

6. The cream dispenser device with wireless heating of claim 1, wherein said heating means comprises an induction coil with said electrical contacts on the outer surface of said housing, and said induction coil energizing the heating chamber when said electrical contacts are engaged with a power source.

7. The cream dispenser applicator device with wireless heating of claim 1, wherein said flow channel of said heating chamber has loop pattern for increasing dwell time of said cream inside said heating chamber.

8. The cream dispenser applicator device with wireless heating of claim 1, wherein said heating chamber is controlled by a temperature sensor, which functions as an electrical switch for current input to said heating chamber.

9. The cream dispenser applicator device with wireless heating of claim 1, wherein said heating means includes a battery providing electrical current to said heating chamber.

10. The cream dispenser applicator device with wireless heating of claim 1, wherein said lower frame of said housing having threaded collar and said cartridge having a threaded sleeve for mounting on the threaded collar of said housing.

11. The cream dispenser applicator device with wireless heating of claim 1, wherein said upper frame being attached with a razor blade unit forming a combination device having a dispenser cartridge and a razor blade unit.

12. A cream dispenser applicator device with wireless heating comprising:
i. a housing having a lower frame and an upper frame,
ii. a cream dispenser attached to the lower frame of said housing, said dispenser having a cartridge with an output nozzle containing a cream, a pumping means with an actuator for dispensing said cream,
iii. a heating chamber heated by a receiver-induction coil energized by a transmitter coil, and said heating chamber having a flow channel with an input port receiving said cream from said cartridge and an output port, and
iv. an applicator head attached to the upper frame of said housing being in communication with said heating chamber, said cream exits from said applicator head when said actuator of said cream dispenser is depressed to apply a pumping pressure.

13. The cream dispenser applicator device with wireless heating of claim 12, wherein said transmitter coil is included in a power pad external to said device housing.

14. The cream dispenser applicator device with wireless heating of claim 12, wherein said flow channel of said heating chamber has loop pattern for increasing dwell time of said cream inside said heating chamber.

15. The cream dispenser applicator device with wireless heating of claim 12, wherein said heating chamber is controlled by a temperature sensor, which functions as an electrical switch for current input to said heating chamber.

16. The cream dispenser applicator device with wireless heating of claim 1, wherein said upper frame being attached with a brush unit forming a combination device having a dispenser cartridge and a brush unit.

17. The cream dispenser applicator device with wireless heating of claim 12, wherein said upper frame being attached with a razor blade unit forming a combination device having a dispenser cartridge and a razor blade unit.

18. The cream dispenser applicator device with wireless heating of claim 12, wherein said upper frame being attached with a brush unit forming a combination device having a dispenser cartridge and a brush unit.
